(19) United States
(12) Patent Application Publication
(10) Pub. No.: US 2014/0137756 A1
(43) Pub. Date: May 22, 2014

(54) GALLEY TRASH COMPACTOR

(71) Applicant: DRIESSEN AIRCRAFT INTERIOR SYSTEMS INC., Garden Grove, CA (US)

(72) Inventor: Thomas M. Lee, Coto de Caza, CA (US)

(73) Assignee: DRIESSEN AIRCRAFT INTERIOR SYSTEMS INC., Garden Grove, CA (US)

(21) Appl. No.: 14/086,095

(22) Filed: Nov. 21, 2013

Related U.S. Application Data
(60) Provisional application No. 61/729,099, filed on Nov. 21, 2012.

(51) Int. Cl. B30B 9/30; B30B 15/30

(52) U.S. Cl. CPC B30B 9/3003; B30B 15/30
USPC 100/100; 100/215

(57) ABSTRACT

Embodiments of the invention described herein thus provide various features that help maximize the use of the trash compartment space on single aisle aircraft. There is provided an integral compacting system, as well as a translating bin system. These features may be used alone or in combination with one another.

### CROSS REFERENCE TO RELATED APPLICATIONS

This application claims the benefit of U.S. Provisional Application Ser. No. 61/729,099, filed Nov. 21, 2012, titled “Galley Trash Compactor,” the entire contents of which are hereby incorporated by reference.

### FIELD OF THE INVENTION

Embodiments of the present invention relate generally to trash compactors designed for use in passenger transport vehicle galleys. Embodiments find particular use on-board aircraft, which typically have very limited space and weight constraints but generate large amounts of trash.

### BACKGROUND

Collecting and disposing of trash in confined conditions, particularly on-board passenger transport vehicles, such as aircraft, trains, ships, buses, RVs, and other water or air travel vessels can be challenging. However, a good deal of rubbish is generated on such vehicles. For example, on a passenger aircraft, after in-flight beverage service, unused items are collected. These items often include drink cups, napkins, newspapers, food wrappers, tea bags, beverage cans, other packaging or non-consumable items and the like, food wastes, or any other type of disposable item that creates waste after consumption. Typically, waste items are compacted on-board passenger transport vehicles in order to preserve space.

It is desirable to compact trash and other unused items so that the materials collectively take up less space in the galley area. However, it is also desirable that the trash compactor unit be appropriately sized and as efficient as possible. It is further desirable that the trash compactor be as light as possible, particularly if intended for use on board a passenger aircraft, where excess weight translates directly to increased fuel costs.

On-board trash compactors are typically provided as a full-sized unit, typically the size of a full or half size meal cart, in the galley. This takes up valuable or non-existent space, particularly in a single aisle or aft galley. Accordingly, improved compacting options are needed.

### BRIEF SUMMARY

Embodiments of the invention described herein thus provide various features that help maximize the use of the trash compartment space, particularly on-board on single aisle aircraft. There is provided an integral compacting system, as well as a translating bin system. These features may be used alone or in combination with one another.

### BRIEF DESCRIPTION OF THE DRAWINGS

FIG. 1 shows a front plan view of an aft galley, showing trash storage compartments on the side areas of the galley.

FIG. 2 shows a front view one example of an aircraft galley with the trash door panel removed to show the interior space of the compartment.

FIG. 3 shows a front view of the galley of FIG. 2 with an integral trash compactor and waste flap in place on the compartment.

FIG. 4 shows one embodiment of a potential low force compactor that may be used in the systems described herein.

FIG. 5A and 5B show the scissors linkage in retracted and extended positions.

FIG. 6 shows one embodiment of another potential low force compactor that may be used in the systems described herein.

FIG. 7 shows a schematic of various inputs that may be delivered to the trash compactor system.

FIG. 8 shows a top view of the aft galley configuration with an emergency slide bustle blocking the trash storage area during flight.

FIG. 9 shows a front view of a translating trash bin in place in a trash storage compartment.

FIG. 10 shows a front view of an upper rail for allowing sliding of the trash compactor and/or bin forward.

FIG. 11 shows a front perspective view of the space with a trolley moved, prior to a side sliding movement of the translating bin.

FIG. 12 shows a front view of FIG. 11 with the translating bin having been translated into the space.

FIG. 13 shows a front schematic of a bin in an outward translated position and a rear track system.

FIG. 14A shows a top view of one embodiment of a bin in the waste collection position. FIG. 14B shows a top view of the bin in a translated position.

FIG. 15A shows a side view of one embodiment of a bin in the waste collection position. FIG. 15B shows a side view of the bin in a translated position.

FIG. 16 shows a side schematic view of a bin with one or more hinges to rotate for trash removal.

FIG. 17 shows a side schematic view of a bin with one or more base hinges to rotate for trash removal.

FIG. 18 shows an alternate embodiment having a foldable platen.

### DETAILED DESCRIPTION

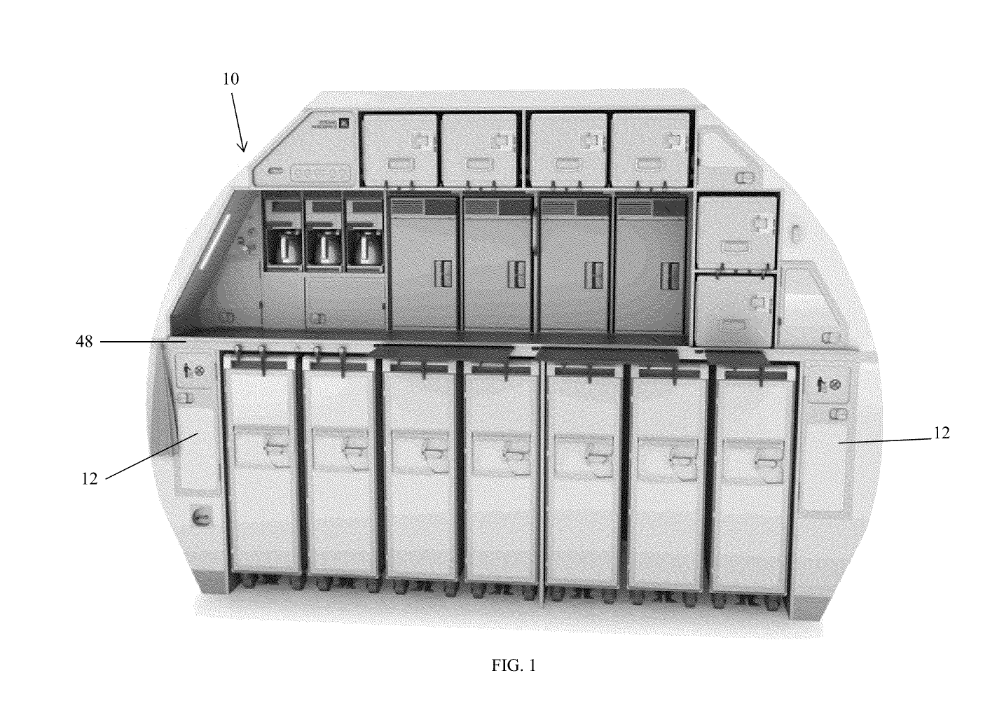

FIG. 1 shows an aircraft galley 10 of the type that is typically positioned at the aft of an aircraft. This galley 10 is shown as having multiple storage compartments and carts, as well as small trash storage compartments 12 on either side of the galley. These trash storage compartments 12 positioned at the sides of the galley in order to make the best use of space due to various curvatures at the aft of the aircraft. Not many other components can be positioned in that space because an aircraft fuselage is curved at the sides and tapers inwardly toward the aft. Thus, trash storage compartments 12 are actually oddly shaped and are generally smaller than optimal. Rather than being rectangular, the compartments 12 are more triangularly shaped, and other components are not designed for this space.

Although single aisle aircraft generally have an on-board trash cart (for collecting trash in the aisles), they do not generally have on-board trash compactors due to space and weight considerations. However, installing a full size trash compactor takes up valuable space that can otherwise be used for paying customer seats. Thus, improved trash management solutions on-board passenger transport vehicles, and particularly single aisle aircraft, is critical.

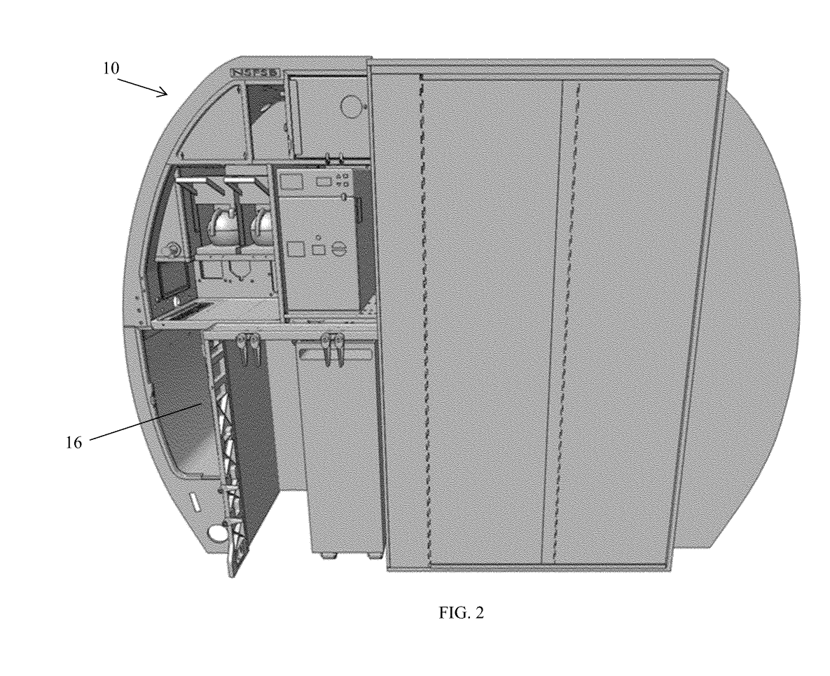

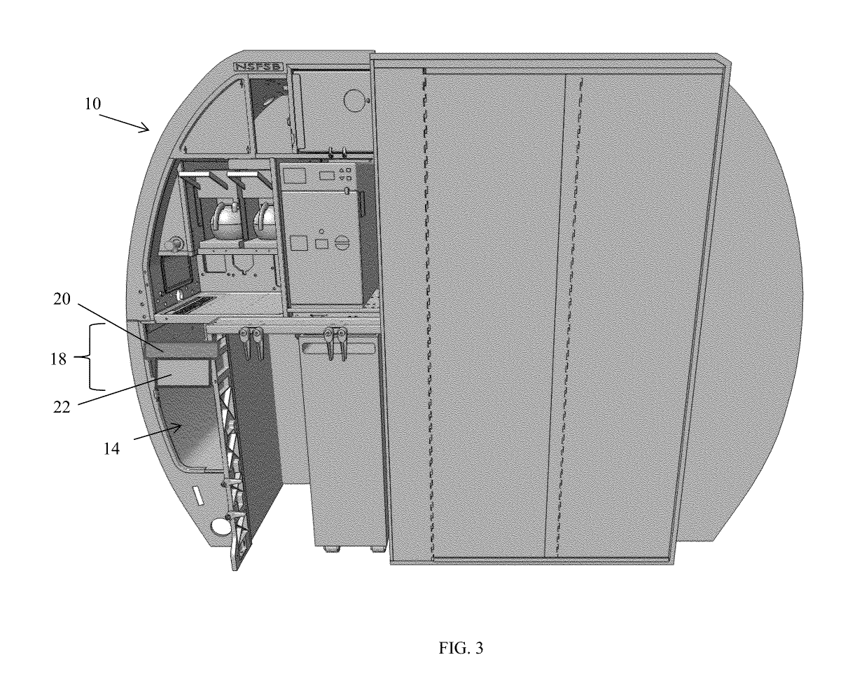

FIG. 2 shows the interior 16 of the trash storage compartment 14 with the door removed. This image illustrates how the interior 16 of the compartment 14 reflects the internal curvature of the fuselage and how it tapers toward the back. This compartment 14 may hold a bin 15 (describe further below) and provides a space 18 for an integrated compactor 20 to be installed at an upper portion of the compartment 14. In one embodiment, the integrated compactor 20 is positioned above a trash flap 22. (The trash flap 22 may be a touchless waste flap, such that a sensor recognizes when a user's hand is nearby and opens the flap.) During manufacture of the aircraft galley 10, an integrated compactor 20 may be built directly into the compartment 14 of the galley structure 10. An example of the integrated compactor 20 may be positioned above the trash flap 22 is shown in FIG. 3. In an alternate embodiment, the integrated compactor 20 may be built into a translatable bin 15 that fits into the compartment 14, described further below.

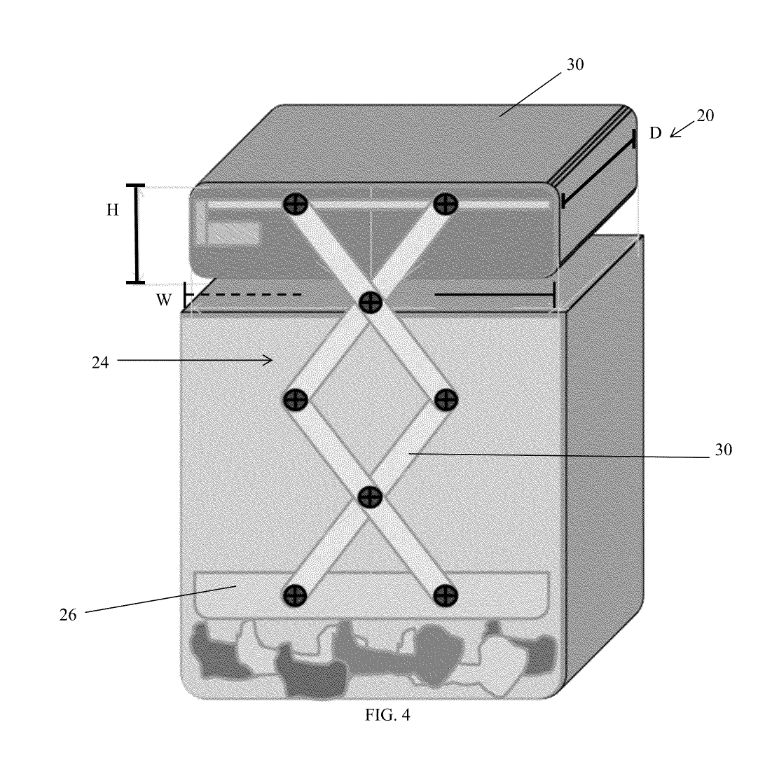

FIG. 4 shows a side view of a schematic of one embodiment a compactor 20. In one embodiment, the compactor 20 is generally a low force compactor. This term is used to refer to a compactor that does not use a full hydraulic system for compressing trash, but instead uses an alternate system that requires less space and power. For example, the power delivered by the compactor 20 may generally be about 6700N (or about 1500 pounds) at 300 W. Other forces may be provided by altering the amount of power delivered. However, it is generally desirable to balance the amount of power and force delivered with providing a compact unit that can be provided in the small compartment space.

As shown in FIG. 4, the compactor 20 may have a scissor mechanism 24 that controls movement of a platen 26. The scissor mechanism 24 is shown as a double scissor element 28 that, when compressed or collapsed in a non-use position, fits inside a compactor housing 30. The scissor element 28 may comprise ball bearings and hinged arms to cause its smooth movement.

In one embodiment, the compactor housing 30 may range from about 2 to 4 inches in height (H), about 12-16 inches wide (W), and about 10-12 inches deep (D). In a particular embodiment, the compactor housing 30 is about 3.2 inches in height, about 15 inches wide, and about 11 inches deep. These dimensions are common dimensions for the upper areas 18 of existing trash compartments 14 in the aft galley area. Installing a compactor 20 in such a compartment 14 thus does not require a re-work of the existing galley structure 10.

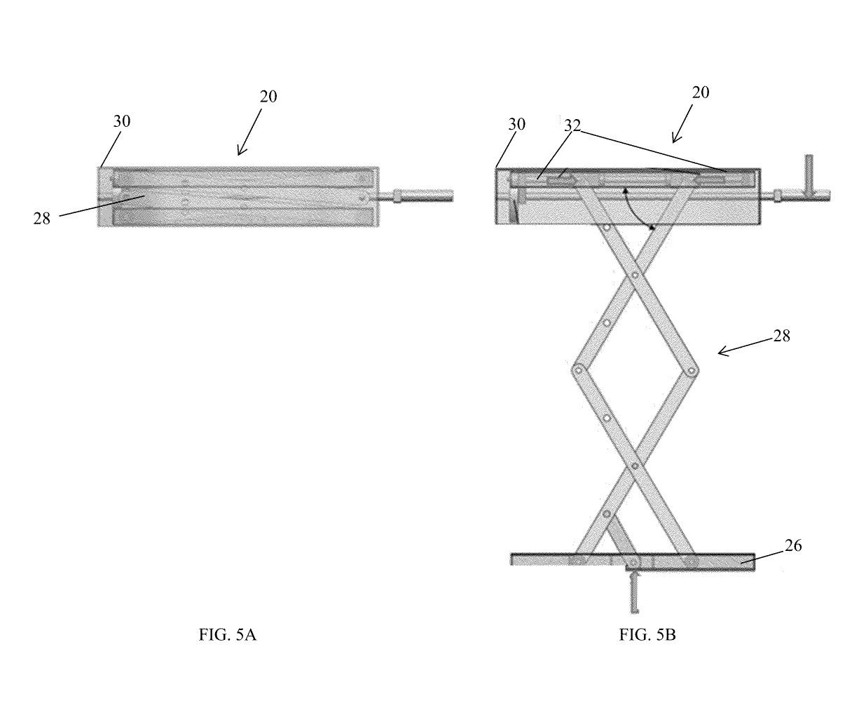

An example of a compressed double scissor element 28 is shown in FIG. 5A. An example of the double scissor element 28 extended to force the platen 26 to compress trash is shown in FIG. 5B. These figures also show drive actuators 32 which are activated to cause extension and retraction of the double scissor element 28.

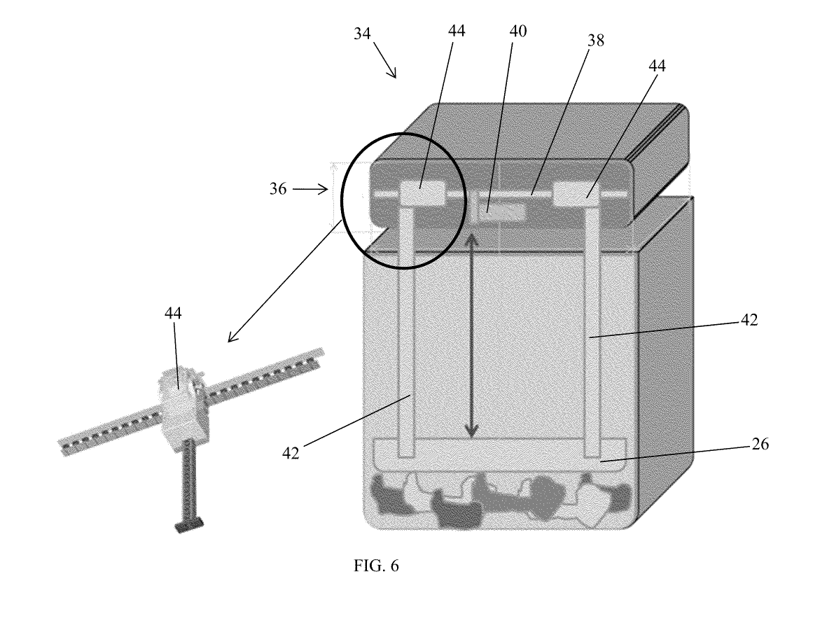

Alternate low force compression compactors may also be used and are considered within the scope of this disclosure. For example, possible compression mechanics include but are not limited to a push chain actuator, a mechanical jack, a single scissor jack, jackscrew, flapper mechanism, linear drive and cam gear configuration, or any other option, many of which are understood by one of ordinary skill in the art. FIG. 6 illustrates one embodiment of a push chain system 34. The push chain system 34 uses a rigibelt 36 system that is a rigid telescoping lifting column that uses back-to-back timing belts that engage and lock, much like a zipper. The rigibelt 36 includes an upper horizontal element 38, along which a push chain actuator 40 is positioned. Two vertical “chains” 42 are driven by timing belts 44. These elements cooperate in order to raise and lower a platen 26.

In one embodiment, the rigibelt 36 may be made of reinforced plastic. Because of its lightweight material, the push chain system 34 generally has a lesser force capacity than the scissor embodiment described above, as generally has a capacity of about 10-1000 N (or about 2-225 pounds).

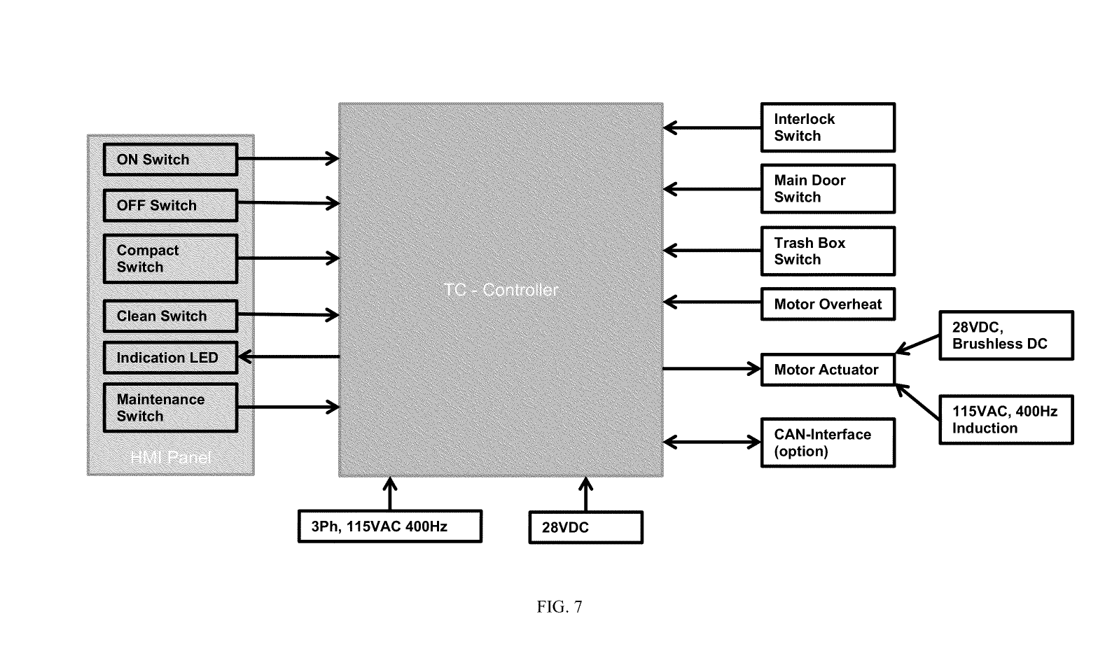

A schematic showing various activation options for the trash compactor controller system, such as the drive actuators 32 and/or timing belts 44, is shown in FIG. 7. This schematic shows that the trash compactor may be turned on/off by a switch, and may also have a compacting switch, a cleaning switch, a maintenance switch, and an LED light, all on an HMI (human machine interface) panel. Other safety switches may be provided, such as an interlock switch, a main door switch , a trash box switch, and a motor overheat warning.

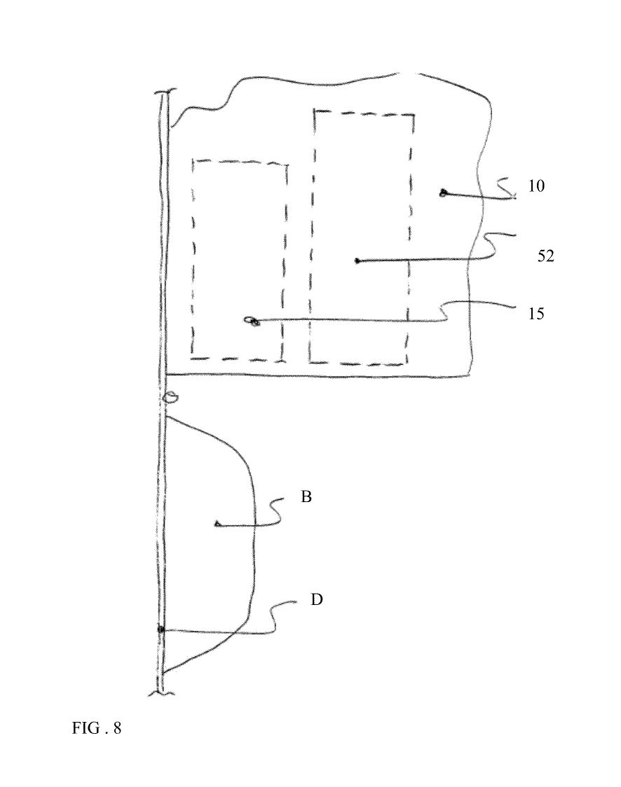

Another feature that may be provided in the improved trash compartment 14 is to provide a bin 15 that is slidable or otherwise accessible for trash removal. This feature is referred to as a translating bin system. This feature is useful because in some instances, the aft galley may have emergency slides that are stored in a bustle at the aft. An example of this blockage is shown in FIG. 8, which illustrates the trash compartment 14 blocked by the emergency slide bustle B. The storage of these slides can prevent easy access to the trash compartment 14 when the rear door D of the aircraft is closed, such as during flight time and passenger loading. (If the rear door D of the aircraft is opened, a ground maintenance person can simply open the door on the front of the trash compartment 14 and pull the trash bin forward and out for cleaning But this access is blocked when the door D is closed and thus, an appropriate in-flight solution must be provided.)

Accordingly, the bin 15 may be provided on a track such that the bin 15 is rendered moveable. The track may be positioned along an upper portion of the bin, along a back portion of the bin, or a combination thereof. This could allow the attendant to slide the bin 15 away from the internal shape of the fuselage compartment 14 for easier access to empty the bin 15.

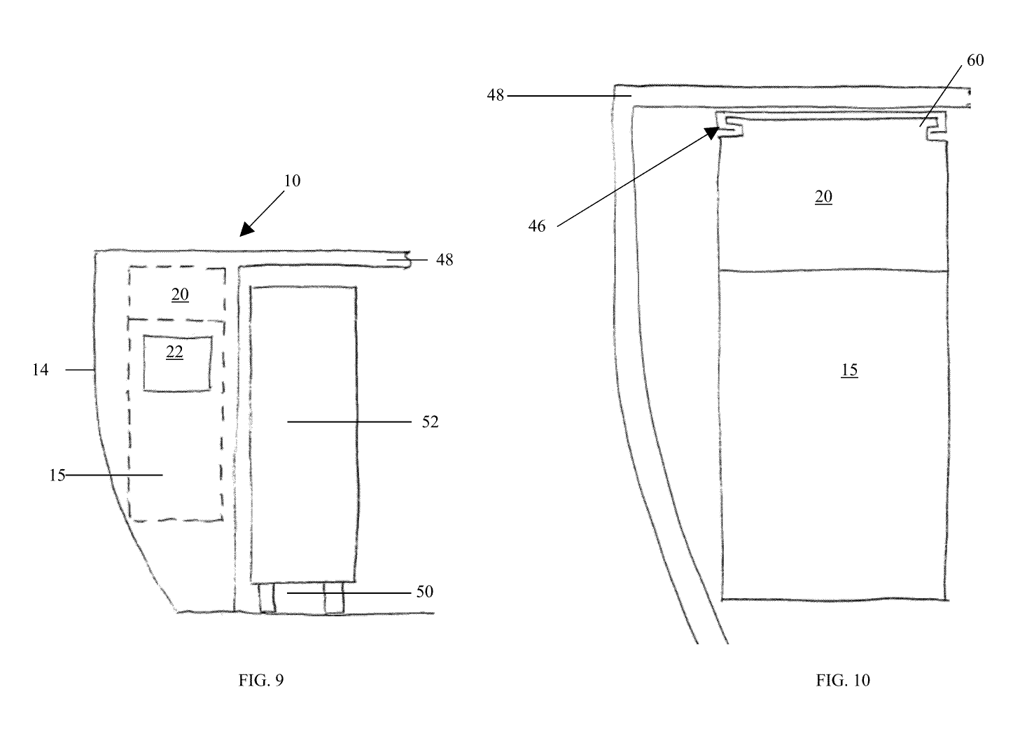

FIG. 9 shows a front view of a galley 10 with a bin 15 in place in the compartment 14 and a trolley 52 positioned in the space 50 next to the bin 15. In order to provide translation of the bin 15, a track system 46 may be mounted beneath a galley panel 48, as shown in FIG. 10. For perspective, FIG. 1 illustrates that the panel 48 may be a surface that supports one or more galley components, such as ovens, chillers, beverage makers, or any other components. The panel 48 may also help define the lower space 50 into which one or more trolleys 52 may be positioned. In the embodiment shown, a track 46 may be provided to allow the forward movement of the bin 15 and/or a compacting unit 20. This could allow removal of the entire system for ground maintenance (e.g., when the aircraft in on the ground and the door D can be opened). A similar track may 46 may be provided in the opposite direction in order to allow the bin 15 and/or the compacting unit 20 to translate side to side.

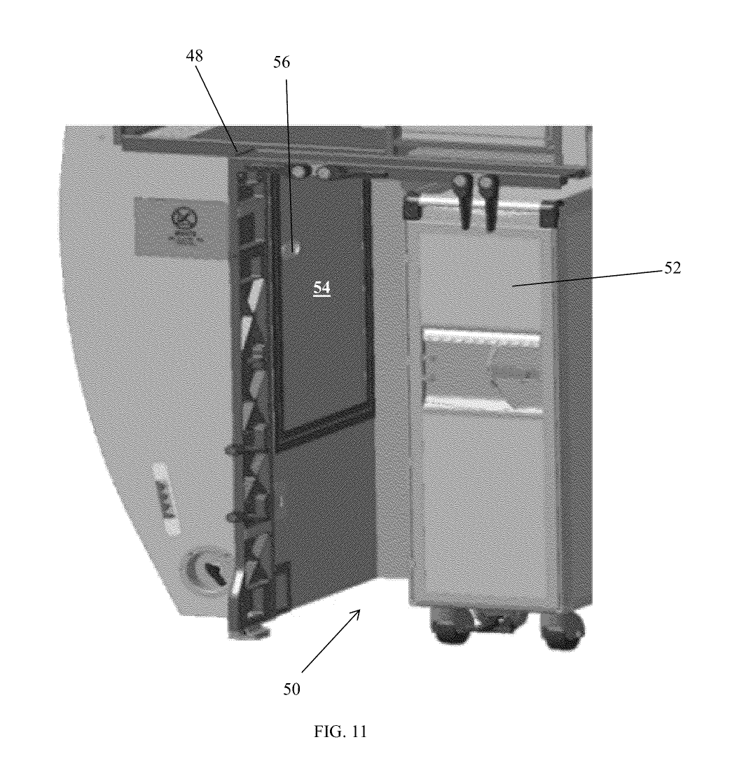

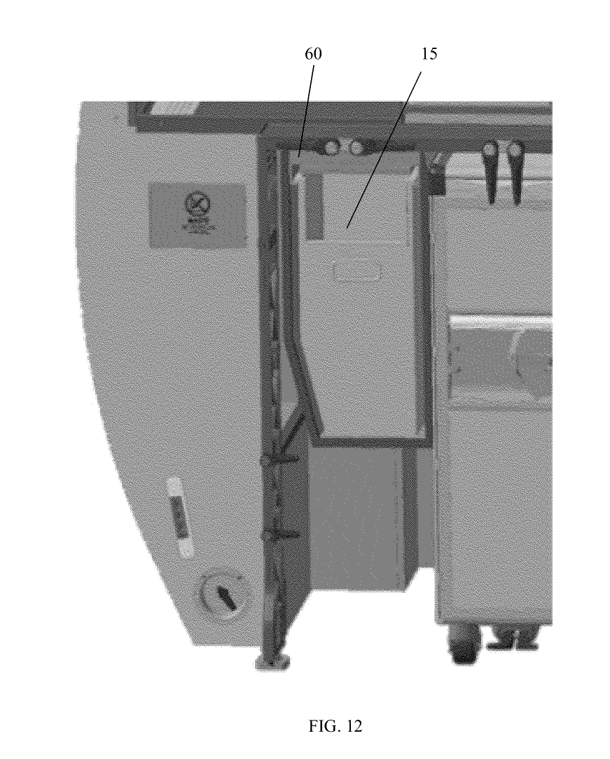

As shown in FIG. 11, one or more of the trolleys 52 may be moved away in order to provide an open space 50. A side face 54 of the bin 15 may then be revealed. Side face 54 may have a finger access 56, which can allow a user to grasp the access 56. As shown in FIG. 12, the bin 15 may then be pulled or slid to the right, in the direction shown by arrow 58. The corresponding compartment on the opposite side of the galley 10 may also be configured to similarly move inward (which would be to the left in the perspective view of the aft galley 10 in FIG. 1).

In one embodiment, the bin 15 may have one or more track cooperating features at its upper portion that slide along or otherwise cooperate with the track 46. One example is shown in FIG. 10. The track cooperating feature may be one or more rollers, a groove 60 to cooperate with track flanges as shown, or any other appropriate feature. The cooperation between the translation bin 15 and the track 46 may be similar to the cooperation between rollers of a drawer along an internal track of a drawer opening.

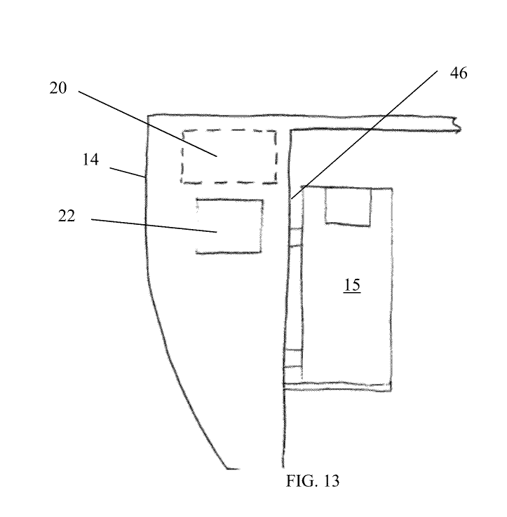

In another embodiment, the track cooperating feature may be positioned at the back of the bin 15 and a track 46 may be mounted on a back wall of the galley structure, such that the back wall of the bin 15 translates against the back of the galley, as shown in FIG. 13.

FIGS. 14A and 14B shows a top plan view of an embodiment showing the bin 15 and an upper track rail 46 along which the bin 15 translates. In FIG. 14A, the bin 15 is in the normal use/trash collection position. In FIG. 14B, the bin 15 has been translated out to a trash removal position.

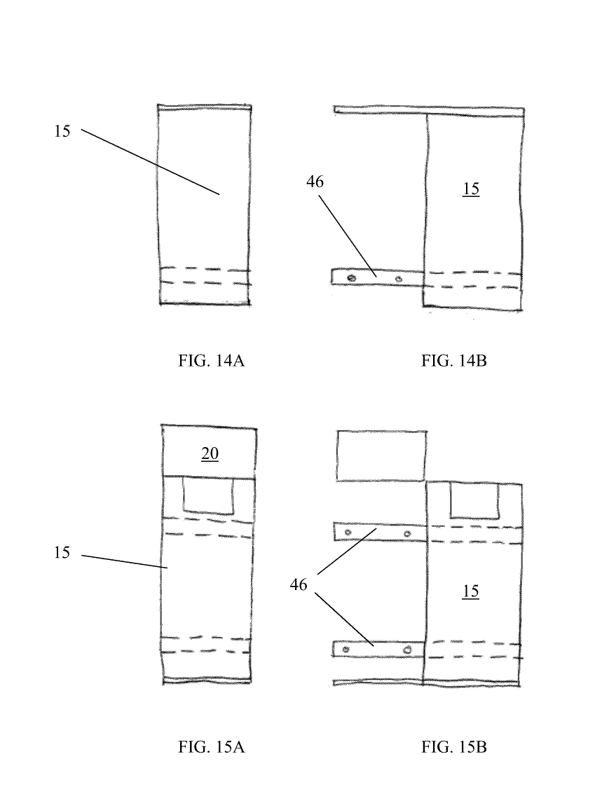

FIGS. 15A and 15B show a side plan view of an embodiment showing the bin 15 and two rear track rails 46 along which the bin 15 translates. (It should be understood that more than two tracks may also be provided if desired.) In FIG. 15A, the bin 15 is in the normal use/trash collection position. In FIG. 15B, the bin 15 has been translated out to a trash removal position. A compactor 20 may be provided that is integrated into the galley structure and does not move with the bin 15. Alternatively, a compactor may either be integrally formed with the bin 15 such that it moves with the bin 15 or no compactor need be provided. Any combination of these features may also be provided.

In a further embodiment, the track 46 may be designed to allow the bin 15 to be pulled forward. This may be in addition to or instead of the side movement. For example, once the bin 15 has been pulled to the side, it may then be pulled forward so that the attendant can access the interior of the bin 15 from the front. The translating bin may this translate side to side, as well as forward to aft.

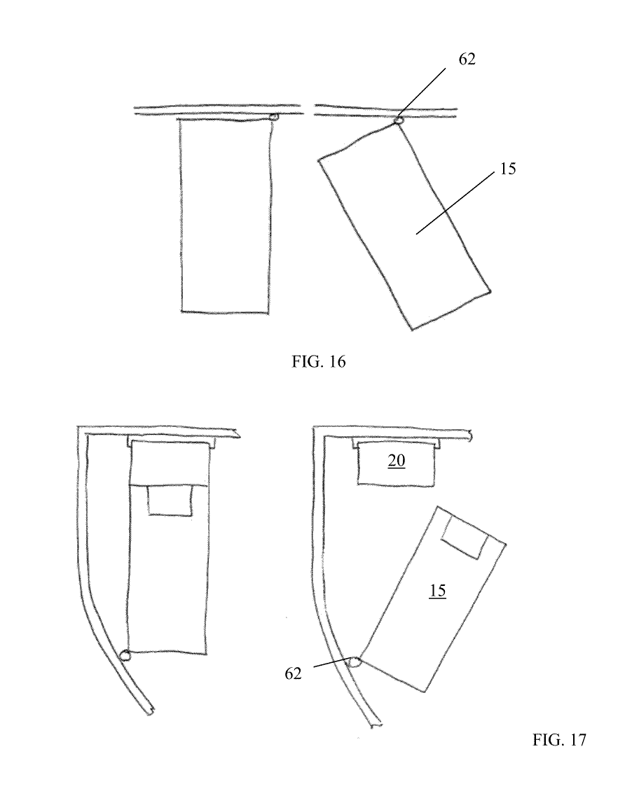

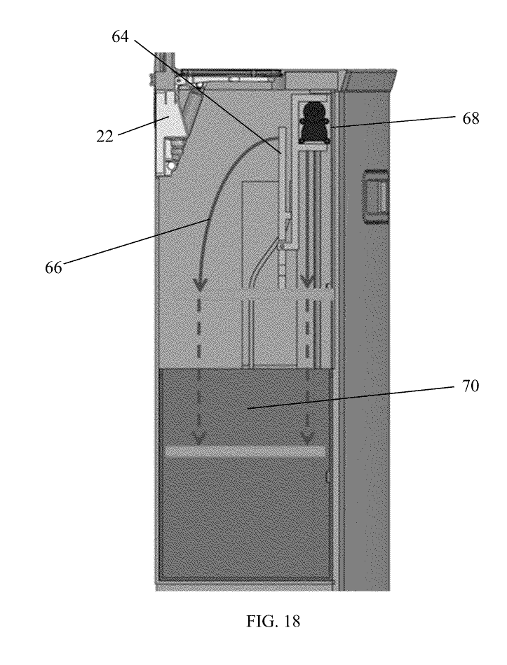

Additionally or alternatively, the bin 15 may be designed to tilt outwardly so that the contents are more easily accessible. This may be accomplished via one or more hinges 62 at one or more corners of the bin. Examples are shown in FIGS. 16 and 17. For example, once the bin 15 has been pulled to the side, it may be tilted forward or to the side, so that the attendant can access the interior of the bin 15 in order to replace a bag or carton into the bin 15. FIG. 16 shows a hinge 62 positioned along an upper portion of the bin 15. FIG. 17 shows a hinge 62 positioned along a lower rear portion of the bin 15. In this embodiment, a stationary compactor 20 remains in place while the bin 15 rotates outwardly. It should be understood that one or more hinges may be positioned along any surface to assist with tilting as well.

The bin 15 may be designed to house a trash compactor carton or to hold a plastic garbage bag. The bin 15 is generally provided as having sufficient structural rigidity that it can withstand compaction forces in order to compress the trash stored in bin 15.

This translating bin system may be incorporated with the integral trash compactor 20 feature describe above. For example, in one embodiment, the trash compactor 20 may be integral with the bin 15, so that the compactor 20 and the bin 15 move together. In another embodiment, the trash compactor 20 may be integral with the compartment 14 near the upper portion 18 and secured with respect to the galley wall, so that the compactor 20 is not moved when the bin 15 slides out or translates.

Without wishing to be bound to any theory, it is believed that a design that allows the compaction unit 20 to remain in a fixed position in the compartment 14 may assist with compaction forces and help eliminate user error in instances when the translating bin 15 is not fully locked back into position. However, it may be found that the compacting unit 20 should remain fixed in relation to the bin 15, and in this instance, the compactor 20 can be made translatable, along with the translating bin system.

The translating bin 15 may have a locking feature for maintaining the translating bin 15 locked in place when not in translation. For example, the locking feature may lock the bin 15 in the trash storage compartment 14 area. Additionally or alternatively, the locking feature may lock the bin 15 in its outwardly translated position.

FIG. 18 shows a further embodiment which provides a foldable platen 64. The platen 64 is designed to fold up into the vertical position. A user deposits trash into the waste flap 22 and the trash is collected in the bin area 70. During this step, the platen 64 is in its vertical position. Once a sensor or input activates that a compaction cycle should begin, the platen 64 is activated to move from its vertical position to a horizontal compaction position, as illustrated by arrow 66. This may be accomplished via one or more actuators 68.

It should be understood that the features described herein may be enhanced when used in combination with one another, although they may also be used separately. A particular aircraft may choose to customize its trash collection process such that an integral compactor may be provided with a sliding compactor and/or a foldable platen or any other appropriate combination.

Changes and modifications, additions and deletions may be made to the structures and methods recited above and shown in the drawings without departing from the scope or spirit of the invention and the following claims.

What is claimed is:

1. A trash storage system for use in a galley structure on-board a passenger transport vehicle, comprising:
(a) a trash storage compartment;
(b) a translating bin configured to fit into the trash storage compartment;
(c) a compaction unit integrally formed with the trash storage compartment or integrally formed with the translating bin;
(d) a track on the galley structure;
(e) a track cooperating feature on the translating bin, such that the translating bin can translate out of the trash storage compartment with respect to the galley structure.

2. The system of claim 1, further comprising two sets of tracks, one set of tracks for translating the bin from side to side, and another set of tracks for translating the bin forward to aft.

3. The system of claim 1, wherein the translating bin comprises a side face with a finger access.

4. The system of claim 1, wherein the translating bin further comprises one or more hinges to allow the trash storage compartment to tilt outwardly.

5. The system of claim 1, wherein the track cooperating feature comprises one or more rollers.

6. The system of claim 1, wherein in use, the translating bin is caused to slide along the track on the galley structure to allow easy access to the translating bin.

7. The system of claim 1, wherein the track on the galley structure comprises a track that is below a galley panel that defines a space for trolley storage.

9. The system of claim 1, wherein the track of the galley structure comprises a track positioned along a back galley wall.

10. The system of claim 1, wherein the compaction unit comprises a low force compaction unit.

11. The system of claim 10, wherein the low force compaction unit comprises a scissor mechanism.

12. The system of claim 10, wherein the low force compaction unit comprises a push chain system.

13. The system of claim 1, wherein the compaction unit comprises a foldable platen.

14. A translating bin system for use in a galley structure on-board a passenger transport vehicle, comprising:
(a) a trash storage compartment;
(b) a translating bin configured to fit into the trash storage compartment;
(c) a panel on the galley structure comprising a track;
(d) a track cooperating feature on the translating bin, such that the translating bin can translate with respect to the galley structure;
(e) a side face of the translating bin comprising a finger access for a user to grasp the translating bin and cause it to translate along the track; and
(f) a locking feature for maintaining the translating bin locked in place when not in translation.

15. The system of claim 14, further comprising a compaction unit integrally formed with the trash storage compartment.

16. The system of claim 14, further comprising a compaction unit integrally formed with the translating bin.

17. The system of claim 14, wherein the translating bin further comprises one or more hinges to allow the translating bin to tilt outwardly.

18. A galley trash compactor for an aircraft, comprising:
(a) a trash storage compartment located in an aft galley of the aircraft;
(b) a compaction unit integrally formed and mounted in the trash storage compartment.
